(19) United States
(12) Patent Application Publication
(10) Pub. No.: US 2022/0206190 A1
(43) Pub. Date: Jun. 30, 2022

(54) SILICONE-BASED ADHESIVE PROTECTION FILM AND OPTICAL MEMBER COMPRISING SAME

(71) Applicant: Samsung SDI Co., Ltd., Yongin-si, Gyeonggi-do (KR)

(72) Inventors: Yoo Jin SUH, Suwon-si (KR); Tae Ji KIM, Suwon-si (KR); Won KIM, Suwon-si (KR); Il Jin KIM, Suwon-si (KR); Bong Soo PARK, Suwon-si (KR)

(21) Appl. No.: 17/594,562

(22) PCT Filed: Apr. 22, 2020
(86) PCT No.: PCT/KR2020/005285

§ 371 Date: Oct. 22, 2021

(30) Foreign Application Priority Data
Apr. 22, 2019 (KR) 10-2019-0046923

(51) Int. Cl. G02B 1/14; C08G 77/20; G02B 1/04; C08G 77/00

(52) U.S. Cl. CPC G02B 1/14; C08G 77/20; G02B 1/16; C08G 77/70; G02B 1/04

(57) ABSTRACT

Provided are a silicone-based adhesive protection film and an optical member comprising same, the protection film being formed of a composition comprising an alkenyl group-containing organic polysiloxane, an organic polysiloxane resin, a siloxane-based ionic compound, a cross-linking agent, and a hydrosilylation catalyst, wherein the organic polysiloxane resin includes an organic polysiloxane resin comprising a R¹R²R³SiO_{1/2} unit (R¹, R², and R³ are each independently an alkyl group having 1 to 6 carbon atoms) and a SiO_{4/2} unit.

### TECHNICAL FIELD

The present invention relates to a silicone-based adhesive protective film and an optical member comprising the same.

### BACKGROUND ART

The use, storage and manufacturing environments of optical displays are becoming harsh. In addition, interest in new optical displays, such as wearable devices, foldable devices, and the like, is also increasing. As a result, an adhesive protective film for protecting a panel of the optical display is required to have various properties. In particular, with the development of a panel having a compact structure and high flexibility, there is a need for development of an adhesive protective film that allows less damage to the panel and less change in properties thereof even under severe conditions upon removal of the adhesive protective film.

Accordingly, an acrylate or urethane acrylate-based adhesive protective film has been developed in the art. However, when the acrylate or urethane acrylate-based adhesive protective film attached to an adherend is left for a long period of time, peel strength of the adhesive protective film to the adherend increases excessively, thereby causing damage to and/or deformation of the adherend upon removal of the adhesive protective film therefrom while deteriorating processability due to difficulty in removal of the protective film.

The background technique of the present invention is disclosed in Korean Patent Laid-open Publication No. 2012-0050136 and the like.

### DISCLOSURE

### Technical Problem

It is one object of the present invention to provide a silicone-based adhesive protective film that provides good protection with respect to an adherend, good wettability, and good step embedding properties.

It is another object of the present invention to provide a silicone-based adhesive protective film having a low peel strength increase rate over time.

It is a further object of the present invention to provide a silicone-based adhesive protective film that exhibits a low residual peel strength reduction rate and good residue properties to prevent contamination of and damage to an adherend when peeled off of the adherend.

It is yet another object of the present invention to provide a silicone-based adhesive protective film having good antistatic properties.

### Technical Solution

One aspect of the present invention relates to a silicone-based adhesive protective film.

1. The silicone-based adhesive protective film is formed of a composition including an alkenyl group-containing organic polysiloxane, an organic polysiloxane resin, a siloxane-based ionic compound, a crosslinking agent and a hydro-silylation catalyst, wherein the organic polysiloxane resin includes an organic polysiloxane resin including an R¹R²R³SiO_{1/2} unit (R¹, R² and R³ being each independently a C₁ to C₆ alkyl group) and a SiO_{4/2} unit.

2. In 1, the silicone-based adhesive protective film may have a peel strength of about 3 gf/25 mm or less with respect to an adherend.

3. In 1 and 2, the silicone-based adhesive protective film may have a peel strength increase rate of about 50% or less, as calculated by Equation 1:

Peel strength increase rate=(P2−P1)/P1×100, [Equation 1]

where P1 denotes an initial peel strength (unit: gf/25 mm) of the silicone-based adhesive protective film with respect to an adherend in a specimen of the silicone-based adhesive protective film and the adherend; and

P2 denotes a peel strength (unit: gf/25 mm) of the silicone-based adhesive protective film with respect to the adherend of the specimen, as measured after the specimen is left at 50° C. for 3 days.

4. In 1 to 3, the silicone-based adhesive protective film may have a residual peel strength reduction rate of about 25% or less, as calculated by Equation 2:

Residual peel strength reduction rate=(M2−M1)/M2×100, [Equation 2]

where M1 denotes a peel strength (unit: gf/25 mm) of an adhesive tape upon removal of the adhesive film from an adherend of a specimen, as measured after the silicone-based adhesive protective film is removed from the specimen and the adhesive tape is attached to a surface of the specimen having the silicone-based adhesive protective film removed therefrom and is left at 25° C. for 30 minutes, in which the specimen is prepared by attaching a stack of the silicone-based adhesive protective film and a release film to the adherend via the silicone-based adhesive protective film, left at 50° C. for 3 days, and cooled at 25° C. for 30 minutes; and

M2 denotes a peel strength (unit: gf/25 mm) of the adhesive tape with respect to an initial adherend having no silicone-based adhesive protective film attached thereto.

5. In 1 to 4, the silicone-based adhesive protective film may have a surface resistance of about 1.0×10¹⁰Ω/□ to about 1.0×10¹³Ω/□ (ohm/sq).

6. In 1 to 5, the siloxane-based ionic compound may include a siloxane group-bonded cation-anion conjugate.

7. In 6, the siloxane group may include a siloxane group free from a C₂ to C₁₀ alkenyl group.

8. In 6, the cation may include pyridinium, pyridizinium, pyrimidinium, pyrazinium, imidazolium, pyrazolium, thiazolium, oxazolium or triazolium cations, and the anion may include at least one selected from the group of perfluoroalkylsulfonate, cyanoperfluoroalkylsulfonylimide, bis(cyano)perfluoroalkylsulfonylmethide, bis(perfluoroalkylsulfonyl)imide, bis(perfluoroalkylsulfonyl) methide, and tris(perfluoroalkylsulfonyl)methide.

9. In 1 to 8, the siloxane-based ionic compound may be present in an amount of about 0.001 parts by weight to about 3 parts by weight relative to 100 parts by weight of the alkenyl group-containing organic polysiloxane.

10. In 1 to 9, the organic polysiloxane resin may be free from a C₂ to C₁₀ alkenyl group.

11. In 1 to 10, the R¹R²R³SiO_{1/2} unit (R¹, R² and R³ being each independently a C₁ to C₆ alkyl group) and the SiO_{4/2} unit may be present in a mole ratio of about 0.5:1 to about 1.5:1 in the organic polysiloxane resin.

12. In 1 to 11, the organic polysiloxane resin may be present in an amount of about 0.01 parts by weight to about 20 parts by weight relative to 100 parts by weight of the alkenyl group-containing organic polysiloxane.

13. In 1 to 12, the alkenyl group-containing organic polysiloxane may include a mixture of a component (i) and a component (ii):

Component (i): an organic polysiloxane having at least one silicon-bonded C₂ to C₁₀ alkenyl group.

Component (ii): an organic polysiloxane having at least one silicon-bonded vinyl group.

14. In 13, the component (i) may be present in an amount of about 30 parts by weight to about 70 parts by weight and the component (ii) may be present in an amount of about 30 parts by weight to about 70 parts by weight relative to 100 parts by weight of the mixture.

15. In 14, the composition may further include an anchoring agent.

Another aspect of the present invention relates to an optical member including an optical film and a silicone-based adhesive protective film formed on one surface of the optical film, wherein the silicone-based adhesive protective film is the silicone-based adhesive protective film according to the present invention.

### Advantageous Effects

The present invention provides a silicone-based adhesive protective film that provides good protection with respect to an adherend, good wettability, and good step embedding properties.

The present invention provides a silicone-based adhesive protective film having a low peel strength increase rate.

The present invention provides a silicone-based adhesive protective film that exhibits a low residual peel strength reduction rate and good residue properties to prevent contamination of and damage to an adherend when peeled off of the adherend.

The present invention provides a silicone-based adhesive protective film having good antistatic properties.

### BEST MODE

Hereinafter, embodiments of the present invention will be described in detail with reference to the accompanying drawings. However, it should be understood that the present invention is not limited to the following embodiments and may be embodied in different ways. The following embodiments are provided to provide a thorough understanding of the invention to those skilled in the art.

Herein, “vinyl group” (Vi) means *—CH═CH₂ (* being a linking site).

Herein, “hexenyl group” (Hex) may be a 1-hexenyl group, a 2-hexenyl group, a 3-hexenyl group, a 4-hexenyl group or a 5-hexenyl group, preferably a 5-hexenyl group.

Herein, “Me” may be a methyl group and “Ph” may be a phenyl group.

Herein, “adherend” may include a glass plate (preferably, an alkali-free glass plate) or a plastic film, such as a polyimide film, an acryl film, a polyacrylamide film, and the like. Preferably, the adherend may be a glass plate.

Herein, peeling may be performed at a temperature of 23° C. to 28° C., preferably 23° C. to 26° C., in measurement of peel strength.

As used herein to represent a specific numerical range, the expression “X to Y” means a value greater than or equal to X and less than or equal to Y (X≤ and ≤Y).

The inventors of the present invention developed a silicone-based adhesive protective film using a composition including an alkenyl group-containing organic polysiloxane, a crosslinking agent and a hydro-silylation catalyst, and further including an organic polysiloxane resin and a silicone-based ionic compound described below.

The silicone-based adhesive protective film exhibits good peel strength with respect to an adherend to provide good effects in protection of the adherend and allows less increase in peel strength when stored in a state of being attached to the adherend, thereby providing good storage stability without deformation of and/or damage to the adherend upon removal of the silicone-based adhesive protective film from the adherend. In addition, the silicone-based adhesive protective film has good step embedding properties and/or wettability with respect to an adherend to prevent generation of bubbles when the silicone-based adhesive protective film is attached to the adherend, thereby providing good processability upon cutting a stack of the silicone-based adhesive protective film and the adherend. Further, the silicone-based adhesive protective film can prevent contamination of or damage to an adherend through improvement in residual peel strength reduction rate upon removal of the silicone-based adhesive protective film from the adherend after the silicone-based adhesive protective film is attached to the adherend, thereby providing good processability. Furthermore, the silicone-based adhesive protective film has surface resistance within the above range, thereby providing good antistatic properties.

Hereinafter, a silicone-based adhesive protective film according to one embodiment of the present invention will be described.

The silicone-based adhesive protective film is formed of a composition including an alkenyl group-containing organic polysiloxane, an organic polysiloxane resin, a siloxane-based ionic compound, a crosslinking agent, and a hydro-silylation catalyst, wherein the organic polysiloxane resin includes an organic polysiloxane resin including an R¹R²R³SiO_{1/2} unit (R¹, R² and R³ being each independently a C₁ to C₆ alkyl group) and a SiO_{4/2} unit.

The composition free from the organic polysiloxane resin can suffer from increase in peel strength. The composition free from the siloxane-based ionic compound can suffer from problems of increase in peel strength increase rate and residual peel strength reduction rate over time.

<Alkenyl Group-Containing Organic Polysiloxane>

The alkenyl group-containing organic polysiloxane forms a matrix of the silicone-based adhesive protective film.

The alkenyl group-containing organic polysiloxane may be present alone, preferably as a mixture. Specifically, the alkenyl group-containing organic polysiloxane may include a mixture of a component (i) and a component (ii) to form a silicone-based adhesive protective film having a peel strength of about 3 gf/25 mm or less with respect to an adherend, whereby the silicone-based adhesive protective film has good peel strength with respect to the adherend to provide good protection to the adherend and can be easily removed therefrom. In one embodiment, the silicone-based adhesive protective film may have a peel strength of greater than about 0 gf/25 mm to about 3 gf/25 mm, for example, about 1 gf/25 mm to about 3 gf/25 mm.

Component (i): an organic polysiloxane having at least one silicon-bonded C₂ to C₁₀ alkenyl group.

Component (ii): an organic polysiloxane having at least one silicon-bonded vinyl group.

The alkenyl group-containing organic polysiloxane including the component (i) alone can cause deterioration in step embedment and/or wettability. The alkenyl group-containing organic polysiloxane including the component (ii) alone can cause increase in peel strength and deterioration in residual adhesive strength.

In the silicone-based adhesive protective film, the component (i) can prevent excessive increase in peel strength of the silicone-based adhesive protective film so as to fall within a desirable range according to the present invention.

In the component (i), the C₂ to C₁₀ the alkenyl group may include, for example, a vinyl group or a C₃ to C₁₀ alkenyl group, for example, a propenyl group, a butenyl group, a pentenyl group or a hexenyl group, preferably a vinyl group or a hexenyl group, more preferably a hexenyl group. The alkenyl group, more preferably the hexenyl group, has an effect of controlling peel strength over time while increasing crosslinking density through rapid reaction.

The component (i) may be an organic polysiloxane containing a linear alkenyl group at a side chain thereof and may include a diorganosiloxane unit containing a C₂ to C₁₀ alkenyl group at a side chain thereof. The component (i) may be free from a vinyl group at both ends thereof.

For example, the component (i) may include an R¹R²SiO_{2/2} unit, where R¹ is a C₂ to C₁₀ alkenyl group, preferably a vinyl group or a hexenyl group, more preferably a hexenyl group, and R² is a C₁ to C₁₀ alkyl group, for example, a methyl group, an ethyl group, or a propyl group.

In the component (i), the R¹R₂SiO_{2/2} may be present in an amount of about 0.01 mmol/g to about 0.5 mmol/g, preferably about 0.1 mmol/g to about 0.3 mmol/g, in the organic polysiloxane. Within this range, the composition for the silicone-based adhesive protective film can have a suitable crosslinking density.

In one embodiment, the component (i) may be an organic polysiloxane represented by Formula 1:

(R¹R²SiO_{2/2})x(R³R⁴SiO_{2/2})y, [Formula 1]

where R¹ is a C₂ to C₁₀ alkenyl group;

R² is a C₁ to C₁₀ alkyl group;

R³ and R⁴ are each independently a C₁ to C₁₀ alkyl group or a C₂ to C₁₀ alkenyl group; and

0<x≤1, 0≤y<1, and x+y=1.

In one embodiment, the component (i) may be an end-capped organic polysiloxane represented by Formula 1-1:

R⁵R⁶R⁷SiO(R¹R²SiO_{2/2})x(R³R⁴SiO_{2/2})ySiR⁸R⁹R¹⁰, [Formula 1-1]

where R¹ is a C₂ to C₁₀ alkenyl group;

R² is a C₁ to C₁₀ alkyl group;

R³ and R⁴ are each independently a C₁ to C₁₀ alkyl group or a C₂ to C₁₀ alkenyl group;

R⁵, R⁶, R⁷, R⁸, R⁹, and R¹⁰ are each independently a C₁ to C₁₀ alkyl group; and

0<x≤1, 0≤y<1, and x+y=1.

The organic polysiloxane represented by Formula 1 or Formula 1-1 may have a molecular weight of about 50,000 to about 200,000, preferably about 70,000 to about 150,000. Within this range, the composition for the silicone-based adhesive protective film can have a suitable crosslinking density.

In the organic polysiloxane mixture, the component (i) may be a unary organic polysiloxane.

The component (i) may include at least one selected from the group of an organic polysiloxane having Vi(CH₃)SiO_{2/2} and (CH₃)₂SiO_{2/2}, an organic polysiloxane having Vi(CH₃)SiO_{2/2}, an organic polysiloxane having Hex(CH₃)SiO_{2/2} and (CH₃)₂SiO_{2/2}, and an organic polysiloxane having Hex(CH₃)SiO_{2/2}.

Preferably, the component (i) includes at least one selected from the group of an organic polysiloxane consisting of Vi(CH₃)SiO_{2/2} and (CH₃)₂SiO_{2/2} as siloxane units, organic polysiloxane, an organic polysiloxane consisting of Vi(CH₃)SiO_{2/2} as a siloxane unit, an organic polysiloxane consisting of Hex(CH₃)SiO_{2/2} and (CH₃)₂SiO_{2/2} as siloxane units, and an organic polysiloxane consisting of Hex(CH₃)SiO_{2/2} as a siloxane unit.

Preferably, the component (i) is (CH₃)₃SiO-(Hex(CH₃)SiO_{2/2})x((CH₃)₂SiO_{2/2})y-Si(CH₃)₃ (0<x≤1, 0≤y<1, and x+y=1).

In one embodiment, the component (i) may be free from a SiO_{4/2} unit (Q unit).

In the organic polysiloxane mixture, the component (i) may be present in an amount of about 30 parts by weight to about 70 parts by weight, preferably about 40 parts by weight to about 60 parts by weight, relative to a total of 100 parts by weight of the component (i) and the component (ii). Within this range, the organic polysiloxane mixture can provide good wettability to the adhesive protective film while suppressing increase in peel strength. For example, the component (i) may be present in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70 parts by weight, relative to a total of 100 parts by weight of the component (i) and the component (ii) in the organic polysiloxane mixture.

In the silicone-based adhesive protective film, the component (ii) can increase peel strength of the silicone-based adhesive protective film so as to fall within a desirable range according to the present invention.

The component (ii) may be an organic polysiloxane having at least one silicon-bonded vinyl group at one or both ends thereof.

In one embodiment, the component (ii) may be free from a SiO_{4/2} unit (Q unit).

In one embodiment, the component (ii) may be an organic polysiloxane having at least one silicon-bonded vinyl group at both ends thereof and may include a diorganosiloxane unit. For example, the component (ii) may be an organic polysiloxane represented by Formula 2:

R⁵R⁶R⁷SiO(R¹R²SiO^{2/2})x(R³R⁴SiO_{2/2})ySiR⁸R⁹R¹⁰, [Formula 2]

where R¹, R², R³ and R⁴ are each independently a C₁ to C₁₀ alkyl group;

R⁵, R⁶ and R⁷ are each independently a vinyl group or a C₁ to C₁₀ alkyl group,

at least one of R⁵, R⁶ and R⁷ is a vinyl group;

R⁸, R⁹ and R¹⁰ are each independently a vinyl group or a C₁ to C₁₀ alkyl group,

at least one of R⁸, R⁹ and R¹⁰ is a vinyl group; and

0≤x≤1, 0≤y≤1, and x+y=1.

The organic polysiloxane represented by Formula 2 may have a molecular weight of about 10,000 to about 150,000, preferably about 50,000 to about 100,000. Within this range, the composition for the silicone-based adhesive protective film can exhibit suitable reactivity.

Preferably, the organic polysiloxane represented by Formula 2 is Vi(CH₃)₂SiO—((CH₃)₂SiO_{2/2})n-SiO(CH₃)₂Vi (n being an integer of greater than 100 to 2,000).

In another embodiment, the component (ii) may be an organic polysiloxane having at least one silicon-bonded vinyl group at a side chain thereof. For example, the component (ii) may be an organic polysiloxane represented by Formula 3:

(R¹R²SiO_{2/2})x(R³R⁴SiO_{2/2})y(R⁵R⁶SiO_{2/2})z, [Formula 3]

where R¹, R², R³, R⁴, R⁵, and R⁶ are each independently a C₁ to C₁₀ alkyl group, a vinyl group, or a C₆ to C₁₀ aryl group,

at least one of R¹ and R² is a vinyl group; and

0<x≤1, 0≤y<1, 0≤z<1, and x+y+z=1)

In one embodiment, at least one of R³ and R⁴, preferably both R³ and R⁴, may be a C₆ to C₁₀ aryl group.

In one embodiment, at least one of R⁵ and R⁶, preferably both R⁵ and R⁶, may be a C₁ to C₁₀ alkyl group.

Preferably, the organic polysiloxane represented by Formula 3 includes an organic polysiloxane including (Vi(CH₃)SiO_{2/2})x-((CH₃)₂SiO_{2/2})y-(Ph₂SiO_{2/2})z.

In one embodiment, the component (ii) may be an end-capped organic polysiloxane represented by Formula 3-1:

R⁷R⁸R⁹SiO(R¹R²SiO_{2/2})x(R³R⁴SiO_{2/2})y(R⁵R⁶SiO_{2/2})zSiR¹⁰R¹¹R¹², [Formula 3-1]

where R¹, R², R³, R⁴, R⁵, and R⁶ are each independently a C₁ to C₁₀ alkyl group, a vinyl group, or a C₆ to C₁₀ aryl group,

at least one of R¹ and R² is a vinyl group,

R⁷, R⁸, R⁹, R¹⁰, R¹¹, and R¹² are each independently a C₁ to C₁₀ alkyl group; and

0≤x≤1, 0≤y<1, 0≤z<1, and x+y+z=1.

Preferably, the polysiloxane represented by Formula 3-1 includes an organic polysiloxane including (CH₃)₃SiO—(Vi(CH₃)SiO_{2/2})x-((CH₃)₂SiO_{2/2})y-(Ph₂SiO_{2/2})z-Si(CH₃)₃.

The polysiloxane represented by Formula 3 or Formula 3-1 may have a weight of about 50,000 to about 200,000, preferably about 100,000 to about 150,000. Within this range, the composition for the silicone-based adhesive protective film can have a suitable crosslinking density.

In a further embodiment, the component (ii) may be an organic polysiloxane having at least one silicon-bonded vinyl group at a side chain thereof. For example, the component (ii) may be an organic polysiloxane represented by Formula 4:

(R¹R²SiO_{2/2})x(R³R⁴SiO_{2/2})y, [Formula 4]

where R¹, R², R³, and R⁴ are each independently a C₁ to C₁₀ alkyl group, a vinyl group or a C₆ to C₁₀ aryl group,

at least one of R¹ and R² is a vinyl group; and

0<x≤1, 0≤y<1, and x+y=1.

Preferably, the organic polysiloxane represented by Formula 4 includes an organic polysiloxane including (Vi(CH₃)SiO_{2/2})x-((CH₃)₂SiO_{2/2})y.

In one embodiment, the component (ii) may be an end-capped organic polysiloxane represented by Formula 4-1:

R⁵R⁶R⁷SiO(R¹R²SiO_{2/2})x(R³R⁴SiO_{2/2})ySiR⁸R⁹R¹⁰, [Formula 4-1]

where Formula 4-1,

R¹, R², R³, and R⁴ are each independently a C₁ to C₁₀ alkyl group, a vinyl group, or a C₆ to C₁₀ aryl group,

at least one of R¹ and R² is a vinyl group;

R⁵, R⁶, R⁷, R⁸, R⁹, and R¹⁰ are each independently a C₁ to C₁₀ alkyl group; and 0<x≤1, 0≤y<1, and x+y=1.

Preferably, the polysiloxane represented by Formula 4-1 includes an organic polysiloxane including (CH₃)₃SiO—Vi(CH₃)SiO_{2/2})x-((CH₃)₂SiO_{2/2})y-Si(CH₃)₃.

The polysiloxane represented by Formula 4 or Formula 4-1 may have a weight of about 50,000 to about 200,000, preferably about 100,000 to about 150,000. Within this range, the composition for the silicone-based adhesive protective film can have a suitable crosslinking density.

Preferably, in the organic polysiloxane mixture, the component (ii) is a unary organic polysiloxane.

Preferably, in the organic polysiloxane mixture, the component (ii) consists of the polysiloxane represented by Formula 2 alone.

Preferably, in the organic polysiloxane mixture, the component (ii) consists of the polysiloxane represented by Formula 3 alone.

Preferably, in the organic polysiloxane mixture, the component (ii) is a mixture of the polysiloxane represented by Formula 2 and the polysiloxane represented by Formula 4.

Preferably, in the organic polysiloxane mixture, the component (ii) is a mixture of the polysiloxane represented by Formula 3 and the polysiloxane represented by Formula 4.

In the organic polysiloxane mixture, the component (ii) may be present in an amount of about 30 parts by weight to about 70 parts by weight, preferably about 40 parts by weight to about 60 parts by weight, relative to a total of 100 parts by weight of the component (i) and the component (ii). Within this range, the composition can secure good initial peel strength and good wettability of the silicone-based adhesive protective film. For example, the component (ii) may be present in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70 parts by weight relative to a total of 100 parts by weight of the component (i) and the component (ii) in the organic polysiloxane mixture.

<Organic Polysiloxane Resin>

In the silicone-based adhesive protective film, the organic polysiloxane resin serves to control the peel strength increase rate by preventing increase in peel strength of the adhesive protective film over time while increasing initial peel strength thereof.

In one embodiment, the silicone-based adhesive protective film may have a peel strength increase rate of about 50% or less, for example, about 0% to about 30%, as calculated by Equation 1:

Peel strength increase rate=(P2−P1)/P1×100, [Equation 1]

wherein Equation 1,

P1 denotes an initial peel strength (unit: gf/25 mm) of the silicone-based adhesive protective film with respect to an adherend in a specimen of the silicone-based adhesive protective film and the adherend, and

P2 denotes a peel strength (unit: gf/25 mm) of the silicone-based adhesive protective film with respect to the adherend of the specimen, as measured after the specimen is left at 50° C. for 3 days.

In Equation 1, each of P1 and P2 may be in the range of greater than about 0 gf/25 mm to about 3 gf/25 mm or less, for example, in the range of about 1 gf/25 mm to about 3 gf/25 mm.

The organic polysiloxane resin includes an R¹R²R³SiO_{1/2} unit (also referred to as M unit) and a SiO_{4/2} unit (also referred to as Q unit). In Equation 1, R¹, R² and R³ are each independently a C₁ to C₆ alkyl group, for example, a methyl group, an ethyl group, an isopropyl group, or an N-propyl group.

In one embodiment, the organic polysiloxane resin may be non-reactive with respect to the alkenyl group-containing organic polysiloxane.

In one embodiment, the organic polysiloxane resin may be free from a C₂ to C₁₀ alkenyl group, preferably a vinyl group.

In the organic polysiloxane resin, the R¹R²R³SiO_{1/2} unit and the SiO_{4/2} unit may be present in a mole ratio (R¹R²R³SiO_{1/2} unit:SiO_{4/2} unit) of about 0.5:1 to about 1.5:1, preferably about 0.8:1 to about 1.2:1. Herein, the “mole ratio” can be obtained by an area ratio of the SiO_{1/2} unit to the SiO_{4/2} unit, as measured by silicon NMR with respect to the silicone-based adhesive protective film, without being limited thereto.

The organic polysiloxane resin may be present in an amount of about 0.01 parts by weight to about 20 parts by weight, preferably about 0.1 parts by weight to about 10 parts by weight, more preferably about 0.5 parts by weight to about 5 parts by weight, relative to 100 parts by weight of the alkenyl group-containing organic polysiloxane. Within this range, the organic polysiloxane resin can control increase in peel strength of the adhesive protective film over time while securing suitable initial peel strength thereof. For example, the organic polysiloxane resin may be present in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19 or 20 parts by weight relative to 100 parts by weight of the alkenyl group-containing organic polysiloxane.

<Siloxane-Based Ionic Compound>

In the silicone-based adhesive protective film, the siloxane-based ionic compound serves to further decrease the peel strength increase rate of Equation 1 and the residual peel strength reduction rate by reducing initial peel strength while reducing peel strength over time. In addition, the siloxane-based ionic compound facilitates removal of the silicone-based adhesive protective film from an adherend by reducing surface resistance to secure antistatic properties of the silicone-based adhesive protective film. For example, the silicone-based adhesive protective film may have a surface resistance of about 1.0×10¹⁰Ω/□ (ohm/sq) to about 1.0×10¹³Ω/□, preferably about 1.0×10¹¹Ω/□ to about 1.0×10¹³Ω/□.

In one embodiment, the silicone-based adhesive protective film may have a residual peel strength reduction rate of about 25% or less, preferably about 0% to about 25%, as calculated by Equation 2. Within this range, the silicone-based adhesive protective film can prevent contamination of and damage to an adherend upon removal of the silicone-based adhesive protective film from the adherend.

Residual peel strength reduction rate=(M2−M1)/M2×100, [Equation 2]

wherein Equation 2,

M1 denotes a peel strength (unit: gf/25 mm) of an adhesive tape upon removal of the adhesive film from an adherend of a specimen, as measured after the silicone-based adhesive protective film is removed from the specimen and the adhesive tape is attached to a surface of the specimen having the silicone-based adhesive protective film removed therefrom and is left at 25° C. for 30 minutes, in which the specimen is prepared by attaching a stack of the silicone-based adhesive protective film and a release film to the adherend via the silicone-based adhesive protective film, left at 50° C. for 3 days, and cooled at 25° C. for 30 minutes; and

M2 denotes a peel strength (unit: gf/25 mm) of the adhesive tape with respect to an initial adherend having no silicone-based adhesive protective film attached thereto.

In one embodiment, M2 may be in the range of about 800 gf/25 mm to about 1000 gf/25 mm.

The siloxane-based ionic compound may be composed of a siloxane group-bonded cation-anion conjugate or composite. The siloxane group may be coupled to the cation or the anion.

The siloxane group may be non-reactive with respect to the alkenyl group-containing organic polysiloxane and/or the crosslinking agent. The siloxane group may be a siloxane group free from a C₂ to C₁₀ alkenyl group. The composition including the siloxane group containing the C₂ to C₁₀ alkenyl group increases peel strength of the silicone-based adhesive film, thereby securing the effects of the present invention.

With the composition according to the present invention, which includes a cation-anion conjugate or composite free from a siloxane group, the silicone-based adhesive protective film can exhibit insufficient antistatic properties or decrease in peel strength.

In one embodiment, the siloxane group may include at least one selected from the group of an R¹R²R³SiO_{1/2} unit (M unit, R¹, R² and R³ are each a C₁ to C₁₀ alkyl group), an R¹R²SiO_{2/2} unit (D unit, R¹ and R² are each a C₁ to C₁₀ alkyl group), an R¹SiO_{3/2} unit (T unit, R¹ is a C₁ to C₁₀ alkyl group), and a SiO_{4/2} unit (Q unit).

The cation includes a non-polymeric nitrogen onium cation. The non-polymeric nitrogen onium cation may be cyclic or acyclic. The cyclic cation is an aromatic unsaturated cation and cannot be a non-aromatic cation or a saturated cation, and the non-cyclic cation may be a saturated or unsaturated cation. The acyclic cation may be a mono-substituted ammonium cation, a di-substituted ammonium cation, a tri-substituted ammonium cation, or a tetra-substituted ammonium cation.

The cyclic cation may contain one or more heteroatoms other than nitrogen (for example, oxygen or sulfur), and among the cyclic cations, carbon, nitrogen, or the hetero atom may be substituted with a substituent (for example, halogen, an aliphatic linear alkyl group, an aliphatic cyclic alkyl group, an aromatic group, and the like).

The cyclic cation may be selected from the following group, without being limited thereto.

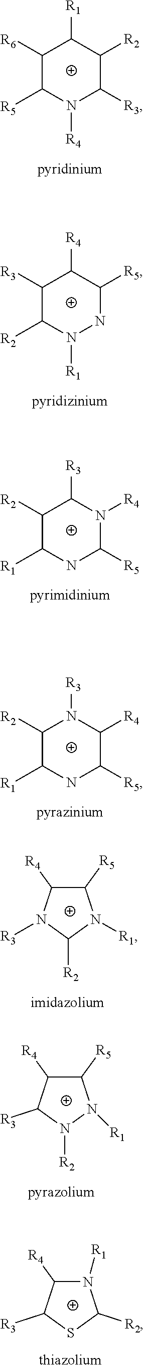

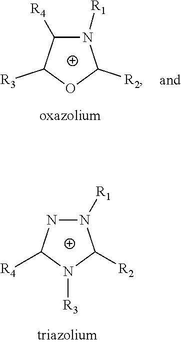

where,

R₁, R₂, R₃, R₄, R₅, and R₆ are each independently hydrogen, a halogen atom, or a C₁ to C₄ alkyl group, and are capable of forming a ring together with a nitrogen or sulfur atom, and the C₁ to C₄ alkyl group or the ring can be substituted with a halogen atom, a fluoroalkyl group, or a fluoroalkylthio group.

Preferably, the cation is imidazolium. The use of imidazolium enables the effects of the present invention to be more efficiently realized.

The anion is a fluorinated organic anion and a pair acid of the fluorinated organic anion may be a peracid. The fluorinated organic anion may be at least one highly fluorinated alkane sulfonyl group, that is, a perfluoroalkane sulfonyl group, or a partially fluorinated alkane sulfonyl group-containing anion.

For example, the anion may include at least one selected from the group of perfluoroalkanesulfonate, cyanoperfluoroalkane sulfonimide, bis(cyano)perfluoroalkane sulfonyl methide, bis(perfluoroalkanesulfonyl)imide, bis(perfluoroalkanesulfonyl)methide, and tris(perfluoroalkanesulfonyl)methide. Preferably, the anion is perfluoroalkanesulfonate, bis(perfluoroalkanesulfonyl)imide, or tris(perfluoroalkanesulfonyl)methide, more preferably bis(perfluoroalkanesulfonyl)imide or tris(perfluoroalkanesulfonyl)methide, most preferably, bis(perfluoroalkanesulfonyl)imide.

The cation-anion conjugate or composite may include at least one selected from the group of the following compounds, without being limited thereto:

octyldimethyl-2-hydroxyethylammonium bis(trifluoromethylsulfonyl)imide: [C₈H₁₇N⁺(CH₃)₂CH₂CH₂OH][⁻N(SO₂CF₃)₂],

octyldimethyl-2-hydroxyethylammonium perfluorobutanesulfonate: [C₈H₁₇N⁺(CH₃)₂CH₂CH₂OH][⁻OSO₂C₄H₉],

octyldimethyl-2-hydroxyethylammonium trifluoromethanesulfonate: [C₈H₁₇N⁺(CH₃)₂CH₂CH₂OH][⁻OSO₂CF₃],

octyldimethyl-2-hydroxyethylammonium tris(trifluoromethanesulfonyl)methide: [C₈H₁₇N⁺(CH₃)₂CH₂CH₂OH][⁻C(SO₂CF₃)₃],

trimethyl-2-acetoxyethylammonium bis(trifluoromethylsulfonyl)imide: [(CH₃)₃N⁺CH₂CH₂OC(O)CH₃][⁻N(SO₂CF₃)₂],

trimethyl-2-hydroxyethylammonium bis(perfluorobutanesulfonyl)imide: [(CH₃)₃N⁺CH₂CH₂OH][⁻N(SO₂C₄F₉)₂],

triethylammonium bis(perfluoroethanesulfonyl)imide: [Et₃N⁺H][—N(SO₂C₂F₅)₂],

tetraethylammonium trifluoromethanesulfonate: [N+(CH₂CH₃)₄][CF₃SO₃⁻],

tetraethylammonium bis(trifluoromethanesulfonyl)imide: [N⁺(CH₂CH₃)₄][(CF₃SO₂)₂N⁻],

tetramethylammonium tris(trifluoromethanesulfonyl)methide: [(CH₃)₄N⁺][⁻C(SO₂CF₃)₃],

tetrabutylammonium bis(trifluoromethanesulfonyl)imide: [(C₄H₉)₄N⁺][⁻N(SO₂CF₃)₂],

trimethyl-3-perfluorooctylsulfone amidopropyl ammonium bis(trifluoromethanesulfonyl)imide: [C₈F₁₇SO₂NH(CH₂)₃N⁺(CH₃)₃][⁻N(SO₂CF₃)₂],

1-hexadecylpyridium bis(perfluoroethanesulfonyl)imide: [n-C₁₆H₃₃-cyc-N⁻C₅H₅][—N(SO₂C₂F₅)_{2]},

1-hexadecylpyridium perfluorobutanesulfonate: [n-C₁₆H₃₃-cyc-N⁺C₅H₅][⁻OSO₂C₄F₉],

1-hexadecylpyridium perfluorooctanesulfonate: [n-C₁₆H₃₃-cyc-N⁺C₅H₅][⁻OSO₂C₈F₁₇],

n-butylpyridium bis(trifluoromethanesulfonyl)imide: [n-C₄H₉-cyc-N⁺C₅H₅][⁻N(SO₂CF₃)₂],

n-butylpyridium perfluorobutanesulfonate: [n-C₄H₉-cyc-N⁺C₅H₅][⁻OSO₂C₄F₉],

1,3-ethylmethylimidazolium bis(trifluoromethanesulfonyl)imide: [CH₃-cyc-(N⁺C₂H₂NCH)CH₂CH₃][⁻N(SO₂CF₃)₂],

1,3-ethylmethylimidazolium nonafluorobutanesulfonate: [CH₃-cyc-(N⁺C₂H₂NCH)CH₂CH₃][⁻OSO₂C₄F₉],

1,3-ethylmethylimidazolium trifluoromethanesulfonate: [CH₃-cyc-(N⁺C₂H₂NCH)CH₂CH₃][⁻OSO₂CF₃],

dodeclmethyl-bis(2-hydroxyethyl)ammonium bis(trifluoromethylsulfonyl)imide: [C₁₂H₂₅N⁺(CH₃)(CH₂CH₂OH)₂][⁻N(SO₂CF₃)₂],

1,2-dimethyl-3-propylimidazolium bis(trifluoromethanesulfonyl)imide,

1,2-dimethyl-3-propylimidazolium tris(trifluoromethanesulfonyl)methide,

1,2-dimethyl-3-propylimidazolium trifluoromethanesulfonyl perfluorobutanesulfonylimide,

1-ethyl-3-methylimidazolium cyanotrifluoromethanesulfonylamide,

1-ethyl-3-methylimidazolium bis(cyano)trifluoromethanesulfonylmethide,

1-ethyl-3-methylimidazolium trifluoromethanesulfonyl perfluorobutanesulfonylimide,

octyldimethyl-2-hydroxyethylammonium trifluoromethylsulfonyl perfluorobutanesulfonylimide,

2-hydroxyethyltrimethyl trifluoromethylsulfonyl perfluorobutanesulfonylimide,

2-methoxyethyltrimethylammonium bis(trifluoromethanesulfonyl)imide,

octyldimethyl-2-hydroxyethylammonium bis(cyano)trifluoromethanesulfonylmethide,

trimethyl-2-acetoxy ethylammonium trifluoromethylsulfonyl perfluorobutanesulfonylimide,

1-butylpyridium trifluoromethylsulfonylperfluorobutanesulfonylimide,

2-ethoxyethyltrimethylammonium trifluoromethanesulfonate,

1-butyl-3-methylimidazolium perfluorobutanesulfonate,

perfluoro-1-ethyl-3-methylimidazolium bis(trifluoromethanesulfonyl)imide,

1-ethyl-2-methylpyrazolium perfluorobutanesulfonate,

1-butyl-2-ethylpyrazolium trifluoromethanesulfonate,

N-ethylthiazolium bis(trifluoromethanesulfonyl)imide,

N-ethyloxazolium bis(trifluoromethanesulfonyl)imide,

1-butylpirimidinyum perfluorobutanesulfonylbis(trifluoromethanesulfonyl)methide,

octyldimethyl-2-hydroxyethylammonium trifluoromethanesulfonate:

[C₈H₁₇N⁺(CH₃)₂CH₂CH₂OH][⁻OSO₂CF₃],

octyldimethyl-2-hydroxyethylammonium bis(trifluoromethylsulfonyl)imide: [C₈H₁₇N⁺(CH₃)₂CH₂CH₂OH][⁻N(SO₂CF₃)₂],

dodecylmethyl-bis(2-hydroxyethyl)ammonium bis(trifluoromethylsulfonyl)imide: [C₁₂H₂₅N⁺(CH₃)(CH₂CH₂OH)₂][⁻N(SO₂CF₃)₂],

octyldimethyl-2-hydroxyethylammonium methanesulfonate,

triethylammonium bis[(trifluoromethyl)sulfonyl]imide,

[(n-C₄H₉)₃(CH₃)N]⁺—[N(SO₂CF₃)₂], and

tri-n-butylmethylammonium bis(trifluoromethanesulfonyl)imide.

The siloxane-based ionic compound may have a liquid phase or a solid phase, preferably a liquid phase, at room temperature (for example, 25° C.). The siloxane-based ionic compound having a liquid phase can exhibit good compatibility with a resin.

The siloxane-based ionic compound may be present in an amount of about 0.001 parts by weight to about 3 parts by weight, preferably about 0.005 parts by weight to about 2 parts by weight, more preferably about 0.01 parts by weight to about 1 parts by weight, most preferably about 0.01 parts by weight to about 0.5 parts by weight, relative to 100 parts by weight of the alkenyl group-containing organic polysiloxane. Within this range, the siloxane-based ionic compound can exhibit good compatibility with the resin and good antistatic properties, and can reduce the peel strength increase rate and the residual peel strength reduction rate. For example, the siloxane-based ionic compound may be present in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2 or 3 parts by weight, relative to 100 parts by weight of the alkenyl group-containing organic polysiloxane.

<Crosslinking Agent>

The crosslinking agent may include hydrogen organopolysiloxane having two or more silicon-bonded hydrogen groups. In one embodiment, the crosslinking agent may be represented by Formula 5:

R⁴R⁵R⁶SiO(R¹R²SiO_{2/2})x(HR³SiO_{2/2})ySiR⁷R⁸R⁹ [Formula 5]

where R¹, R², R³, R⁴, R⁵, R⁶, R⁷, R⁸, and R⁹ are each independently a C₁ to C₁₀ alkyl group, and 0≤x<1, 0<y≤1, and x+y=1.

The crosslinking agent may be present in an amount of about 0.1 parts by weight to about 5 parts by weight, preferably about 0.1 parts by weight to about 3 parts by weight, relative to 100 parts by weight of the alkenyl group-containing organic polysiloxane. Within this range, the silicone-based adhesive protective film can have a suitable crosslinking density. For example, the crosslinking agent may be present in an amount of about 0.1, 0.2, 0.3, 0.4, 0.5, 0.6, 0.7, 0.8, 0.9, 1, 2, 3, 4 or 5 parts by weight relative to 100 parts by weight of the alkenyl group-containing organic polysiloxane.

<Hydro-Silylation Catalyst>

The hydro-silylation catalyst accelerates reaction between the organic polysiloxane and the crosslinking agent. The hydro-silylation catalyst may include a platinum catalyst, a ruthenium catalyst, or an osmium catalyst. Specifically, the hydro-silylation catalyst may include a typical platinum catalyst known to those skilled in the art. For example, the hydro-silylation catalyst may include chloroplatinic acid, an alcohol solution of chloroplatinic acid, a complex of chloroplatinic acid and olefin, a complex of chloroplatinic acid and alkenyl siloxane, and the like.

The hydro-silylation catalyst may be present in an amount of about 0.1 parts by weight to about 3 parts by weight, preferably about 0.5 parts by weight to about 2 parts by weight, relative to 100 parts by weight of the alkenyl group-containing organic polysiloxane. Within this range, the composition can exhibit suitable reactivity. For example, the hydro-silylation catalyst may be present in an amount of 0.1, 0.2, 0.3, 0.4, 0.5, 0.6, 0.7, 0.8, 0.9, 1, 2 or 3 parts by weight relative to 100 parts by weight of the alkenyl group-containing organic polysiloxane.

<Anchoring Agent>

The composition for the silicone-based adhesive protective film may further include an anchoring agent.

The anchoring agent serves to further improve adhesion of the silicone-based adhesive protective film with respect to a base film. The anchoring agent may include a typical siloxane compound known to those skilled in the art. The anchoring agent may include at least one selected from the group of vinyltriethoxysilane, allyltrimethoxysilane, allyltriethoxysilane, 3-glycidoxypropyltrimethoxysilane, and 3-(meth)acryloxypropyltrimethoxysilane.

The anchoring agent may be present in an amount of about 5 parts by weight or less, specifically about 0.05 parts by weight to about 5 parts by weight, preferably about 0.1 parts by weight to about 3 parts by weight, relative to 100 parts by weight of the alkenyl group-containing organic polysiloxane. Within this range, the anchoring agent can further improve adhesion of the silicone-based adhesive protective film with respect to the base film. For example, the anchoring agent may be present in an amount of about 0.05, 0.06, 0.07, 0.08, 0.09, 0.1, 0.2, 0.3, 0.4, 0.5, 0.6, 0.7, 0.8, 0.9, 1, 2, 3, 4 or 5 parts by weight relative to 100 parts by weight of the alkenyl group-containing organic polysiloxane.

The composition for the silicone-based adhesive protective film may further include an organic solvent to form a thin composition layer through improvement in coatability of the composition. The organic solvent may include toluene, xylene, hexane, heptane, and methyl ethyl ketone, without being limited thereto.

The composition for the silicone-based adhesive protective film may further include a hydrosilylation repressor. The hydrosilylation repressor serves to suppress reaction between the alkenyl group-containing organic polysiloxane and the crosslinking agent to form a composition having target viscosity while improving storage stability. The hydrosilylation repressor may include a typical kind of hydrosilylation repressor known to those skilled in the art. For example, the hydrosilylation repressor may include 3-methyl-1-butine-1-ol and 3,5-dimethyl-1-butine-1-ol, without being limited thereto.

The silicone-based adhesive protective film may have a haze of about 5% or less, for example, about 0% to about 1.5%. Within this range, the silicone-based adhesive protective film can be applied to an optical display.

The silicone-based adhesive protective film may have a thickness of about 100 m or less, for example, about 75 m or less, greater than about 0 m to about 75 m. Within this range, the silicone-based adhesive protective film can protect an adherend and can be easily removed therefrom.

The silicone-based adhesive protective film may be formed of the composition for the silicone-based adhesive protective film.

An optical member according to one embodiment of the invention includes an optical film and an adhesive protective film formed on at least one surface of the optical film, wherein the adhesive protective film may include the silicone-based adhesive protective film according to embodiments of the present invention.

The optical film may be a plastic base film. Preferably, the optical film includes a film formed of a polyethylene terephthalate resin. An organic insulation layer or an inorganic insulation layer may be further formed between the optical film and the silicone-based adhesive protective film. Further, the optical film may be subjected to surface treatment or priming treatment in order to improve adhesion to the adhesive protective film. The optical member may further include a release film (liner) on the other surface of the silicone-based adhesive protective film. The release film can prevent contamination of the adhesive protective film due to foreign matter and the like. As the release film, an optical film formed of the same material as or a different material from the aforementioned optical film may be used. For example, the release film may be formed of at least one resin selected from the group of a polyethylene terephthalate resin, a polycarbonate resin, a polyimide resin, a poly(meth)acrylate resin, a cyclic olefin polymer resin, and an acrylic resin. The release film may have a thickness of about 10 m to about 100 m, preferably about 10 m to about 50 m. Within this range, the release film can support the adhesive protective film.

### MODE FOR INVENTION

Next, the present invention will be described in more detail with reference to some examples. However, it should be noted that these examples are provided for illustration only and are not to be construed in any way as limiting the present invention.

### Example 1

In 20 parts by weight of toluene, components of Table 1 excluding SY-ICL_N222B were mixed in amounts as listed in Table 1 to prepare a mixture, which in turn was mixed with a mixture prepared by mixing SY-ICL_N222B in an amount as listed in Table 1 in 20 parts by weight of methyl ethyl ketone, followed by further adding methyl ethyl ketone for dilution, thereby preparing a composition for a silicone-based adhesive protective film.

The prepared composition was deposited to a predetermined thickness on a release film (polyethylene terephthalate film, thickness: 75 m), dried in an oven at 80° C. for 2 minutes and at 130° C. for 3 minutes, and left at room temperature for 3 days, thereby preparing a stack of the silicone-based adhesive protective film (thickness: 25 m) and the release film.

### Examples 2 to 4

Each silicone-based adhesive protective film was prepared in the same manner as in Example 1 except that the kind and amount of each component of a composition for the silicone-based adhesive protective film was changed as listed in Table 1.

### Comparative Examples 1 to 4

Each silicone-based adhesive protective film was prepared in the same manner as in Example 1 except that the kind and amount of each component of a composition for the silicone-based adhesive protective film was changed as listed in Table 1.

The compositions for silicone-based adhesive protective films and/or the silicone-based adhesive protective films prepared in Examples and Comparative Examples were evaluated as to the following properties and results are shown in Table 2.

(1) Initial peel strength (unit: gf/25 mm): The stack of the silicone-based adhesive protective film and the release film prepared in each of Examples and Comparative Examples was cut to a size of 25 mm×100 mm and was bonded to an alkali-free glass plate via the silicone-based adhesive protective film, followed by compression under a 2 kg roller, thereby preparing a specimen. The specimen was left at room temperature for 1 hour. Then, peel strength was measured upon removal of the silicone-based adhesive protective film from the alkali-free glass plate at a peeling rate of 2,400 mm/min and at a peeling angle of 180° using a tensile tester (Texture analyzer, TA Industry) in accordance with JISZ2037. Three specimens were prepared and peel strength was measured with respect to each of the specimens, followed by calculating an average value. This value was defined as initial peel strength.

(2) Peel strength after 3 days at 50° C. (unit: gf/25 mm): A specimen was prepared in the same manner as in (1), left in an oven at 50° C. for 3 days, and cooled outside the oven at room temperature for 30 minutes, followed by measuring peel strength in the same manner as in (1).

(3) Peel strength increase rate (unit: %): A peel strength increase rate was calculated according to Equation 1 using the peel strength values obtained in (1) and (2).

(4) Residual peel strength (M1) (unit: gf/25 mm): After measuring peel strength in (2), an adhesive tape 31B (Nitto Denko Co., Ltd.) was attached to the surface of the alkali-free glass plate, from which the silicone-based adhesive protective film was removed, in the same area as the silicone-based adhesive protective film removed from the alkali-free glass plate. Then, the adhesive tape attached to the alkali-free glass plate was left at room temperature for 30 minutes, followed by measuring residual peel strength (M1) upon removal of the adhesive tape 31B from the alkali-free glass plate at a peeling rate of 300 mm/min and at a peeling angle of 180°. Here, peel strength was measured using a Texture analyzer (TA).

(5) Residual peel strength reduction rate (unit: %): The adhesive tape 31B (Nitto Denko Co., Ltd.) used in (4) was attached to an alkali-free glass plate [initial alkali-free glass plate having no silicone-based adhesive protective film attached thereto] in the same area and left at room temperature for 30 minutes, followed by measuring residual peel strength (M2) upon removal of the adhesive tape 31B from the alkali-free glass plate at a peeling rate of 300 mm/min and at a peeling angle of 180°. The standard peel strength (M2) was 800 gf/25 mm. The residual peel strength reduction rate was calculated according to Equation 2:

Residual peel strength reduction rate=(M2−M1)/M2×100 [Equation 2]

(5) Rubbing-off evaluation: Adhesion between the release film and the silicone-based adhesive protective film was evaluated according to the degree of rubbing off or detachment of the silicone-based adhesive protective film from the release film upon pushing the surface of each of the silicone-based adhesive protective films of Examples and Comparative Examples with a finger.

No rubbing off: ◯

Slight rubbing off: Δ

Rubbing off: X

(6) Surface resistance (unit: Ω/□): Surface resistance of the silicone-based adhesive protective film was measured by applying 100 V for 10 seconds to a surface of the silicone-based adhesive protective film at 25° C. using a surface resistance tester (ST-4, SIMCO-ION).

TABLE 1

| | Example | | | | Comparative Example | | | |
|---|---|---|---|---|---|---|---|---|
| | 1 | 2 | 3 | 4 | 1 | 2 | 3 | 4 |
| DOWSIL | 40 | 40 | 40 | 40 | 40 | 40 | 40 | 40 |
| LTC 750A | | | | | | | | |
| DOWSIL 7646 | 60 | 60 | 60 | 60 | 60 | 60 | 60 | 60 |
| SYL-OFF | 1.5 | 1.5 | 1.5 | 1.5 | 1.5 | 1.5 | 1.5 | 1.5 |
| SL 7028 | | | | | | | | |
| SYL-OFF 4000 | 1.0 | 1.0 | 1.0 | 1.0 | 1.0 | 1.0 | 1.0 | 1.0 |
| DOWSIL 7426 | 1.0 | 1.0 | 1.0 | 1.0 | 0 | 1.0 | 0 | 0 |
| SY-ICL- | 0.01 | 0.05 | 0.1 | 0.01 | 0 | 0 | 0.1 | 0.15 |
| N222B | | | | | | | | |
| SYL-OFF SL | 2.0 | 2.0 | 2.0 | 0 | 2.0 | 2.0 | 2.0 | 2.0 |
| 9250 | | | | | | | | |

TABLE 2

| | Example | | | | Comparative Example | | | |
|---|---|---|---|---|---|---|---|---|
| | 1 | 2 | 3 | 4 | 1 | 2 | 3 | 4 |
| Initial peel strength | 2.05 | 1.93 | 1.87 | 1.90 | 1.54 | 2.13 | 0.81 | 0.73 |
| Peel strength after 3 | 2.49 | 2.38 | 2.29 | 2.34 | 3.15 | 3.27 | 1.48 | 1.35 |
| days at 50° C. | | | | | | | | |
| Peel strength | 21 | 23 | 22 | 23 | 105 | 54 | 83 | 85 |
| increase rate | | | | | | | | |
| Residual peel | 600 | 625 | 637 | 640 | 350 | 380 | 650 | 690 |
| strength | | | | | | | | |
| Residual peel | 25 | 21.9 | 20.4 | 20 | 56.3 | 52.5 | 18.8 | 13.8 |
| strength reduction | | | | | | | | |
| rate (%) | | | | | | | | |
| Rubbing evaluation | ◯ | ◯ | ◯ | ◯ | ◯ | ◯ | Δ | X |
| Surface resistance | 10 × 10^{12.8} | 10 × 10^{12.4} | 10 × 10¹² | 10 × 10^{12.1} | 10 × 10^{13.5} | 10 × 10^{13.5} | 10 × 10¹² | 10 × 10^{11.7} |

*Components used in Table 1 are shown in Table 3.

TABLE 3

| Product name | Classification (Manufacturer) | Description |
|---|---|---|
| DOWSIL LTC | Organic polysiloxane (i) (Dow | Polymethylsiloxane having a hexenyl group at a side chain |
| 750A | Corning) | End-capped with a trimethylsiloxy group |
| DOWSIL 7646 | Organic polysiloxane (ii) | Polydimethylsiloxane having vinyl groups only at both ends |
| | (Dow Corning) | thereof as vinyl group |
| SYL-OFF SL | Crosslinking agent (Dow | Methylhydrogenpolysiloxane |
| 7028 | Corning) | End-capped with a trimethylsiloxy group |
| SYL-OFF 4000 | Hydro-silylation catalyst | Platinum catalyst |
| | (Dow Corning) | |
| DOWSIL 7426 | Organic polysiloxane resin | MQ resin having (CH₃)₃SiO_{1/2} unit only as M unit and SiO_{4/2} |
| | (Dow Corning) | unit |
| SY-ICL-N222B | Siloxane ionic compound | Ionic compound composed of siloxane group-containing |
| | (Sooyang Chemtec Co., Ltd.) | imidazolium-based cation and sulfonyl imide-based anion |
| SYL-OFF SL | Anchoring agent (Dow | SCA |
| 9250 | Corning) | |

As shown in Table 2, the silicone-based adhesive protective films according to this invention had low peel strength increase rates, improved residual peel strength reduction rates, and good antistatic properties.

Conversely, as shown in Table 2, the adhesive protective film of Comparative Example 1 not including the organic polysiloxane resin and the siloxane-based ionic compound according to the present invention had poor properties in terms of peel strength increase rate and residual peel strength reduction rate. The adhesive protective film of Comparative Example 2 not including the siloxane-based ionic compound according to the present invention failed to improve the residual peel strength reduction rate. The adhesive protective films of Comparative Examples 3 and 4 prepared using the siloxane-based ionic compound without the organic polysiloxane resin according to the present invention failed to improve the peel strength increase rate and suffered from deterioration in adhesion in rubbing evaluation.

It should be understood that various modifications, changes, alterations, and equivalent embodiments can be made by those skilled in the art without departing from the spirit and scope of the present invention.

1. A silicone-based adhesive protective film formed of a composition comprising an alkenyl group-containing organic polysiloxane, an organic polysiloxane resin, a siloxane-based ionic compound, a crosslinking agent, and a hydro-silylation catalyst,
wherein the organic polysiloxane resin comprises an organic polysiloxane resin comprising an R¹R²R³SiO_{1/2} unit and a SiO_{4/2} unit, and
wherein R¹, R² and R³ being each independently a C₁ to C₆ alkyl group.

2. The silicone-based adhesive protective film according to claim 1, wherein the silicone-based adhesive protective film has a peel strength of about 3 gf/25 mm or less with respect to an adherend.

3. The silicone-based adhesive protective film according to claim 1, wherein the silicone-based adhesive protective film has a peel strength increase rate of about 50% or less, as calculated by Equation 1:
Peel strength increase rate=(P2−P1)/P1×100, [Equation 1]
where P1 denotes an initial peel strength (unit: gf/25 mm) of the silicone-based adhesive protective film with respect to an adherend in a specimen of the silicone-based adhesive protective film and the adherend; and
P2 denotes a peel strength (unit: gf/25 mm) of the silicone-based adhesive protective film with respect to the adherend of the specimen, as measured after the specimen is left at 50° C. for 3 days.

4. The silicone-based adhesive protective film according to claim 1, wherein the silicone-based adhesive protective film has a residual peel strength reduction rate of about 25% or less, as calculated by Equation 2:
Residual peel strength reduction rate=(M2−M1)/M2×100, [Equation 2]
where M1 denotes a peel strength (unit: gf/25 mm) of an adhesive tape upon removal of the adhesive film from an adherend of a specimen, as measured after the silicone-based adhesive protective film is removed from the specimen and the adhesive tape is attached to a surface of the specimen having the silicone-based adhesive protective film removed therefrom and is left at 25° C. for 30 minutes, in which the specimen is prepared by attaching a stack of the silicone-based adhesive protective film and a release film to the adherend via the silicone-based adhesive protective film, left at 50° C. for 3 days, and cooled at 25° C. for 30 minutes; and
M2 denotes a peel strength (unit: gf/25 mm) of the adhesive tape with respect to an initial adherend having no silicone-based adhesive protective film attached thereto.

5. The silicone-based adhesive protective film according to claim 1, wherein the silicone-based adhesive protective film has a surface resistance of about 1.0×10¹⁰Ω/□ to about 1.0×10¹³Ω/□.

6. The silicone-based adhesive protective film according to claim 1, wherein the siloxane-based ionic compound comprises a siloxane group-bonded cation-anion conjugate.

7. The silicone-based adhesive protective film according to claim 6, wherein the siloxane group comprises a siloxane group free from a C₂ to C₁₀ alkenyl group.

8. The silicone-based adhesive protective film according to claim 6, wherein the cation comprises pyridinium, pyridizinium, pyrimidinium, pyrazinium, imidazolium, pyrazolium, thiazolium, oxazolium or triazolium cations, and the anion comprises at least one selected from the group of perfluoroalkylsulfonate, cyanoperfluoroalkylsulfonylimide, bis(cyano)perfluoroalkylsulfonylmethide, bis(perfluoroalkylsulfonyl)imide, bis(perfluoroalkylsulfonyl) methide, and tris(perfluoroalkylsulfonyl)methide.

9. The silicone-based adhesive protective film according to claim 1, wherein the siloxane-based ionic compound is present in an amount of about 0.001 parts by weight to about 3 parts by weight relative to 100 parts by weight of the alkenyl group-containing organic polysiloxane.

10. The silicone-based adhesive protective film according to claim 1, wherein the organic polysiloxane resin is free from a C₂ to C₁₀ alkenyl group.

11. The silicone-based adhesive protective film according to claim 1, wherein the R¹R²R³SiO_{1/2} unit and the SiO_{4/2} unit are present in a mole ratio of about 0.5:1 to about 1.5:1 in the organic polysiloxane resin.

12. The silicone-based adhesive protective film according to claim 1, wherein the organic polysiloxane resin is present in an amount of about 0.01 parts by weight to about 20 parts by weight relative to 100 parts by weight of the alkenyl group-containing organic polysiloxane.

13. The silicone-based adhesive protective film according to claim 1, wherein the alkenyl group-containing organic polysiloxane comprises a mixture of a component (i) and a component (ii):
Component (i): an organic polysiloxane having at least one silicon-bonded C₂ to C₁₀ alkenyl group;
Component (ii): an organic polysiloxane having at least one silicon-bonded vinyl group.

14. The silicone-based adhesive protective film according to claim 13, wherein the component (i) is present in an amount of about 30 parts by weight to about 70 parts by weight and the component (ii) is present in an amount of about 30 parts by weight to about 70 parts by weight relative to 100 parts by weight of the mixture.

15. The silicone-based adhesive protective film according to claim 1, wherein the composition further comprises an anchoring agent.

16. An optical member comprising: an optical film; and the silicone-based adhesive protective film according to claim 1 formed on one surface of the optical film.
